(19) United States
(12) Patent Application Publication
(10) Pub. No.: US 2009/0076954 A1
(43) Pub. Date: Mar. 19, 2009

(54) METHOD AND SYSTEM FOR SETTLING FINANCIAL TRANSACTIONS

(76) Inventors: Michael D. Carmody, Omaha, NE (US); Michael T. Defreece, Omaha, NE (US); Gary Kiser, Omaha, NE (US)

Correspondence Address: HUSCH BLACKWELL SANDERS LLP, 1620 DODGE STREET, SUITE 2100, OMAHA, NE, 68102, US

(21) Appl. No.: 12/209,805

(22) Filed: Sep. 12, 2008

Related U.S. Application Data
(60) Provisional application No. 60/972,296, filed on Sep. 14, 2007.

(51) Int. Cl. G06Q 40/00

(52) U.S. Cl. 705/40; 705/39

(57) ABSTRACT

A computer-implemented method of facilitating a financial settlement between a multiple users through a fund transfer system is disclosed. The method includes providing a first user with an interface for receiving an instruction to settle, at least in part, a financial obligation to a second user wherein the first user is a registered user of a fund transfer system. A plurality of payment modes suitable for different payment processing are also provided. The instruction is received from the first user wherein and includes an identifier of the second user, financial obligation information, and a payment format suitable for the second user. The value to settle is determined and transferred to the second user.

### CROSS REFERENCE TO RELATED APPLICATIONS

The present Application claims the benefit of and priority as available under 35 U.S.C. § 119 to U.S. Provisional Patent Application 60/972,296, filed Sep. 14, 2007, which is incorporated by reference in its entirety.

### BACKGROUND OF THE INVENTION

The present invention relates to an effective means of electronic financial settlement between a consumer of goods and services and multiple suppliers of goods and services. More particularly, this invention settles financial transactions (invoices due for payment by the consumer to the supplier of goods and services) in a manner, and timeframe desired by the supplier.

The consumer's service provider initiates ACH debits from the consumer's bank account and ACH credits to the consumer's billing account for the authorized payment. Internet banking/bill payment services are offered by various financial institutions and other private service providers throughout the United States. Direct payment and internet banking services provide benefits to both companies and consumers. Companies reduce expenses associated with check processing and improve cash flows by reducing delinquencies and late billing procedures. Consumers reduce check and postage costs and save the time of manually preparing and mailing checks. In addition, consumers can reduce late fees, forget about payment deadlines, and make their account reconciliation process simpler.

The marketplace for automated funds transfer between consumers and suppliers is growing rapidly as is the available technology to support automated payments. Traditional modes of payment are based around standard 30 day payment options, or in some cases, extended payment terms or prompt payment terms. The type of payment offered is negotiated between the consumer and supplier based upon the needs and capabilities of both parties. A problem inherent in the traditional payment process is the ability to settle multiple payments with multiple suppliers under multiple payment terms. Given the time value of money, a great deal of the efficiencies available with present technology is not recognized due to the lack of integrated technology between consumers and supplier as well as processes based on traditional (manual) payment options. Further, some markets are governed by the “third party payment system” (e.g., healthcare). This provides incremental opportunities for financial and process improvement due to the collection of revenue in an extended period of time, and dispersement obligations in a substantially more rapid timeframe. The overall issue is developing a process and associated technology to automate transactions that result in the extension of the payable process to the consumer of goods, while accelerating payment to the supplier of goods.

One solution that automates the payment process for both the supplier of goods and the consumer of goods is the use of credit card facilities (such as American Express, Visa, and MasterCard). These vehicles provide a consumer friendly environment allowing for the extension of payment days and elimination of transactions, along with a general ease of use. However, these credit vehicles are less friendly to the supplier community due to large participation fees, and the necessity for the supplier to modify process to fit the operational model of the credit card companies. Thus, broad based acceptance of credits cards in the business to business supplier community is not common today.

The application of “credits” or essentially reverse transactions also can become significant issues in the business to business trading environment. Often, in the case of a dispute, the consumer of goods and services will not pay valid invoices until the dispute is resolved to their satisfaction. This further creates receivable issues for the Provider of goods and strains relationships between the Provider and supplier. On the other hand, valid credits issued to consumers are often not applied by the consumer. This translates in to accounting irregularities on behalf of the supplier of goods and services. This issue occurs in the traditional environment as well as in the credit card environment. The overall dispute resolution process is costly to both the consumer and the supplier of goods and services.

It is the object of the present invention to provide an end to end settlement process that provides a mechanism to vastly enhance the value of financial settlement to all parties while substantially addressing the aforementioned problems.

This results in improved daily sales outstanding and electronic application of funds. In addition, this invention provides the consumer of goods and services with the ability to settle multiple invoices with a single payment, in an extended timeframe. The resulting process provides the consumer with financial benefits of extended payment days (float), elimination of manual checks, and the ability to earn a rebate based on compliance and volume.

This system thereby facilitates an expedited, yet accurate, means of processing electronic financial settlement between a consumer of goods and services and multiple suppliers of goods and services, which decreases the time necessary for process and decreases the transaction costs associated with that process.

It is evident from the above discussion that an ongoing need exists for improved ways to set up the financial settlement process between consumers and sellers of goods and services.

### BRIEF SUMMARY OF THE INVENTION

The present invention solves the above and other problems, thereby advancing the state of the useful arts, by providing methods and associated systems for enabling an effective way of managing the financial settlement process between consumers and sellers of goods and services.

The invention provides a method of facilitating a financial settlement between a multiple users through a fund transfer system. The method of the present invention comprises steps of: providing a first user with an interface for receiving an instruction to settle, at least in part, a financial obligation to a second user wherein the first user is a registered user of a fund transfer system; providing a plurality of payment modes suitable for different payment processing; receiving said instruction from the first user; determining a value to settle, at least in part, the financial obligation to the second user based, at least in part, upon said instruction and predetermined rules; transferring said determined value to the second user on behalf of the first user from the first user's line of credit on a first schedule wherein said determined value is transferred to the second user by using the payment format suitable for the second user; and receiving funds from the first user to credit the first user's line of credit on a second schedule. The instruction generally includes (1) an identifier of the second user; information on said financial obligation; and a payment format suitable for the second user. In addition, the predetermined rules are associated with contractual terms agreed with the second user.

The present invention reduces the number of payments processed for goods ordered from participating sellers (payees). All payments made on behalf of the customer to all participating sellers are on one monthly or bi-monthly statement. The present invention extends payment terms for the customer. The customer may order goods and authorize payment on a daily basis while extending the payment terms up to 51 days or less.

On the other hand, the present invention allows that cash flow is significantly enhanced as payment is made within days—instead of weeks or even months—after shipment of supplies. The present invention further reduces the accounts receivable balances associated with goods shipped to the customer.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates a block diagram of the financial settlement system in accordance with one embodiment of the present invention;

FIG. 2 illustrates, the general architecture of the system for financial settlement process in accordance with one embodiment of the present invention;

FIG. 3 illustrates the general architecture of the Transaction Processing Application (TPA) for a financial settlement process in accordance with one embodiment of the present invention;

FIGS. 4 and 4A are flow diagrams illustrating the financial settlement process according to an exemplary embodiment of the present invention;

FIGS. 5 and 5A are flow diagrams illustrating the financial settlement process according to an exemplary embodiment of the present invention;

FIGS. 6 and 6A are flow diagrams illustrating the financial settlement process according to an exemplary embodiment of the present invention.

FIGS. 7A and 7B are exemplary graphical user interfaces of the customer's web page according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

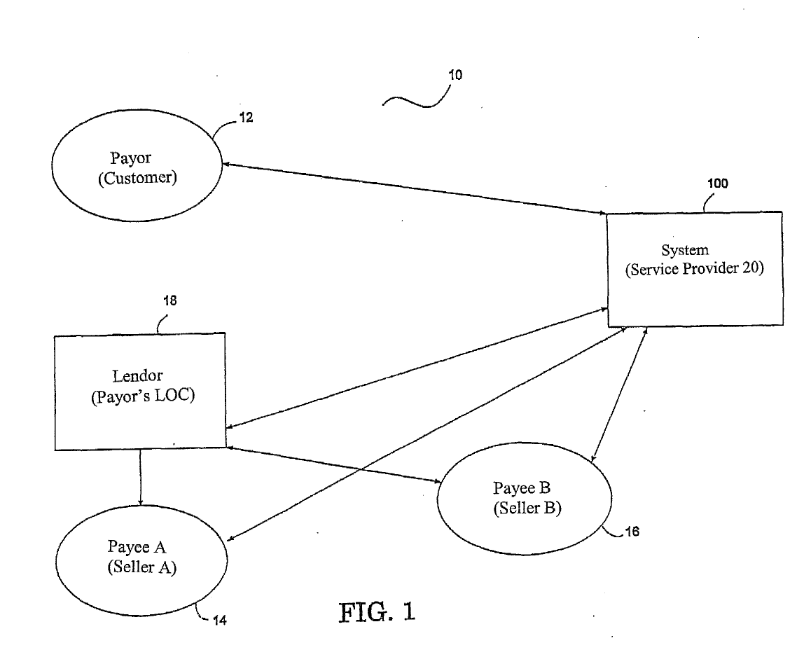

FIG. 1 represents a financial settlement and fund transfer system, and is referred to herein by the general reference numeral 10. A customer (Payor) 12 which has an outstanding balance of a plurality of unpaid bills for Seller A (Payee A) 14 and Seller B (Payee B) 16, registers the service in accordance with the present invention by using an interface via network. Then, the service provider 20 of the present invention checks the credit of the customer 12 and assesses the current trading partners (Seller A 14 and Seller B 16) of the customer 12. In one embodiment, the service provider 20 makes a contract with at least one trading partner 14 for facilitating fast automated invoice settlement. In further embodiment, the service provider 20 can customize the internet based exclusive interface for the trading partner 14, 16 as to the electronic supplier invoice settlement.

After the customer (Payor) 12 sets up an account for this financial settlement and fund transfer, the customer 12 provides the system 100 with a daily or weekly supplier payment authorization. Upon receipt of instructions from the system 100, the customer's line of credit (hereinafter “LOC”) 18 sources a plurality of transfers of funds to the Supplier A (Payee A) 14 according to each of the daily or weekly authorizations. A communications link allows the service provider 20 to direct the lender 18. The customer 12 funds its LOC 18 at a predetermined time frame. The customer's LOC 18 acts like a buffer. Money is transferred to the customer's LOC 18 from the customer checking account (not shown) in amounts and times under the terms agreed between the customer 12 and the system 100. The system 100 also collects a service fee either from the customer 12 or the sellers 14, 16. Many or all of the LOC accounts could be simultaneously managed for many hundreds of customers.

For example, a hospital orders various medical supplies from a Supplier A. One embodiment of the present invention allows the hospital to continue to order at an existing pricing arrangement and receive supplies from Supplier A with no changes to the procurement process. After the order has been received and approved, the hospital will authorize the system 100 of the present invention to make a payment on its behalf to Supplier A. Such payment will be facilitated by a third party lender or insurance company. The hospital will receive a statement from the lender at the end of each month that will summarize the invoices paid during the month and it will have a pre-agreed time period to payoff the balance without interest. On the other hand, the present invention allows Supplier A to continue to receive orders and ship supplies to the hospital with no significant changes to the procurement process or the pricing arrangements with the hospital. After the order has been received and approved, the hospital will authorize the system 100 of the present invention to make a payment on its behalf to Supplier A. Supplier A will receive payment within a few days of shipping the supplies to the hospital.

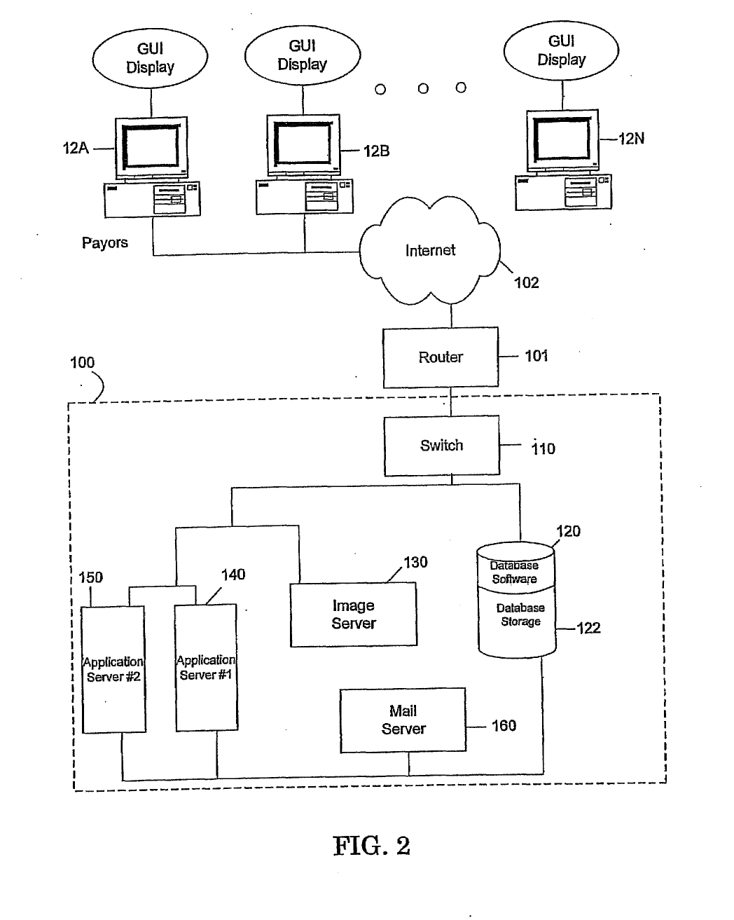

FIG. 2 illustrates the general architecture of a system 100 that operates in accordance with one embodiment of the present invention. As shown in FIG. 2, a plurality of graphical user interface (GUI) displays are presented on a plurality of payor computers 12A, 12B, . . . , 12N connected to a system 100 via a wired or wireless network, such as Internet 102.

The user interface may be any device capable of presenting data, including, but not limited to, cellular telephones, television sets or hand-held “personal digital assistants.” The payor computers 12A, 12B, . . . , 12N may comprise any computing device known in the art, such as a server, mainframe, workstation, personal computer, hand held computer, laptop telephony device, network appliance, etc. As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 2 is for descriptive purposes only. Although the description may refer to terms commonly used in describing particular public networks such as the Internet, the description and concepts equally apply to other public and private computer networks, including systems having architectures dissimilar to that shown in FIG. 2. For example, and without limitation thereto, the system of the present invention can find application in public as well as private networks, such as a closed university social system, or the private network of a company.

The system 100 is connected to the Internet 102 through a router 101 and a switch 110. As is well known in the relevant art(s), routers forward packets between networks. The router 101 forwards information packets between the system 100 and devices 12A, 12B, . . . , 12N over the Internet 102. The switch 110 may act as a gatekeeper to and from the Internet 102. The components appearing in the system 100 refer to an exemplary combination of those components that would need to be assembled to create the infrastructure in order to provide the tools and services contemplated by the present invention. As will be apparent to one skilled in the relevant art(s), all of the components “inside” of the system 100 may be connected and may communicate via a wide or local area network (WAN or LAN).

The system 100 includes an application server 140 or a plurality of application servers 140, 150. Yet another server is the image server 130, which has the purpose of storing and providing digital images to other components of the system 100. Also included is a mail server 160, which sends and receives electronic messages to and from the payor computers 12A, 12B, . . . , 12N. Also included are the database software 122 and a database 124.

The system 100 sends out Web pages in response to Hypertext Transfer Protocol (HTTP) requests from remote browsers (i.e. users of the system 100). That is, the system 100 provides the GUI to users of the system in the form of Web pages. These Web pages sent to the payor computers 12A, 12B, . . . , 12N would result in GUI screens being displayed.

The system 100 also includes a second switch, not shown, that allows the components of the system to be interconnected in a local area network (LAN) or a wide area network (WAN). Thus, data can be transferred to and from the various components of the system 100.

As will be appreciated by those skilled in the relevant art(s), this configuration of a router 101 and switch 110 is flexible and can be omitted in certain embodiments. Additional routers 114 and/or switches 116 can also be added.

The application server 140 may include a central processing unit (CPU), a random access memory (RAM) for temporary storage of information, and a read only memory (ROM) for permanent storage of information. Computer server may be generally controlled and coordinated by an operating system software. The operating system controls allocation of system resources and performs tasks such as processing, scheduling, memory management, networking and I/O services, among other things. Thus, the operating system resident in system memory and executed by CPU coordinates the operation of the other elements of the system 100.

Although the description of the application server 140 may refer to terms commonly used in describing particular computer servers, the description and concepts equally apply to other processing systems, including systems having architectures dissimilar to that shown in FIG. 2.

The mail server 160 is a repository for e-mail messages received from the Internet 102. It also manages the transmission of electronic messages (“electronic mail” or “e-mail”). The mail server 160 consists of a storage area, a set of user definable rules, a list of users and a series of communication modules.

The databases 120, 122 store software, descriptive data, digital images, system data and any other data item required by the other components of the system. The databases may be provided, for example, as a database management system (DBMS), and object-oriented database management system (ODBMS), a relational database management system (e.g. DB2, ACCESS etc.), a file system or another conventional database package. Thus, the databases 120, 122 can be implemented using object-oriented technology or via text files. Further, the databases 120, 122 can be accessed via a Structured Query Language (SQL) or other tools known to one of ordinary skill in the art.

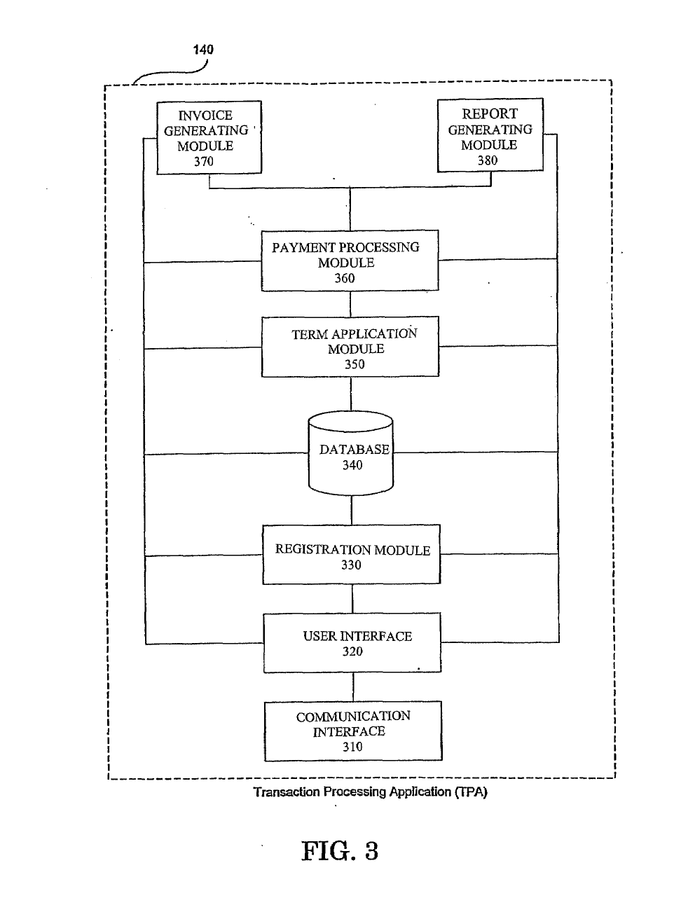

FIG. 3 is a block diagram of a transaction processing application (TPA) 140 according to one embodiment of the invention. In this embodiment, the transaction processing application 140 comprises communication interface 310, user interface 320, registration module 330, database 340, term application module 350, payment processing module 360, invoice generating module 370, and report generating module 380.

Communication interface 310 receives connections from customers and their trading partners, which may include wired and/or wireless links using any suitable communication protocols and architectures. The user interface 320, as described above, may facilitate the generation of HTML code or other computer readable instructions for receiving a customer's authorization for settling a transaction and transferring finds to its trading partner, and/or transmitting to the system 100 relevant details of an electronic transaction for which payment is to be processed, including a multiple payment modes (e.g., INVOICE FEE BASED, INVOICE SHORT PAY, STATEMENT FEE BASED, or STATEMENT SHORT PAY) and a multiple payment formats (e.g., CCD-plus, PPD-plus, CIE). The user interface 320 may also be configured to facilitate creation of an account for customers within the system 100. In one embodiment, the user interface 320 is configured to elicit necessary information from the customer's (payor's) trading partner (payee) to create a new account, retrieve an existing account, identify a desired payment mode and payment format, etc. In one embodiment, the user interface 320 can be customized for a customer as to the electronic supplier payment instructions and negotiated terms. In further embodiment, the user interface 320 provides the customer 12 with a payment template in which to download approved payments for the customer accounts payable system.

Registration module 330 facilitates the generation of new payment processing accounts for customers and their trading partners, while payment processing module 360 interfaces with external financial entities (e.g., banks, credit card issuers, merchant acquirers, ACH vendors) for completing payments from a buyer and/or to a seller. The payment processing module 360 can modify the customer's current payment process to segment participating suppliers. When the customer 12 enters the system, the user's name and password are checked at the administration database (not shown), and if the customer 12 is authorized, he or she may proceed with authorizing payments or settlement. Payment cases may either be for a new supplier or an already established supplier, and if new, the customer 12 may set up conditions for payments.

Database 340 comprises various databases concerning customers (payors) and their trading partners (payees), including an administration database, an account information database, a payment database, a term database, a correspondence database, and a form database. An application executable code consists of the software code executed by the CPU during the operation of the settling transaction system, such operation implemented by various processes and graphical user interfaces (screens) to be described later. The administration database contains user names and passwords for all users that are authorized to use the system 100 (when a user logs in, he or she enters his/her name and password at the input device and they are checked against those stored in the administration database). The term database stores data entered or collected (e.g., at the input device) on terms agreed with individual payee (a customer's trading partner) and that is used to settle transaction between the payor and its payee.

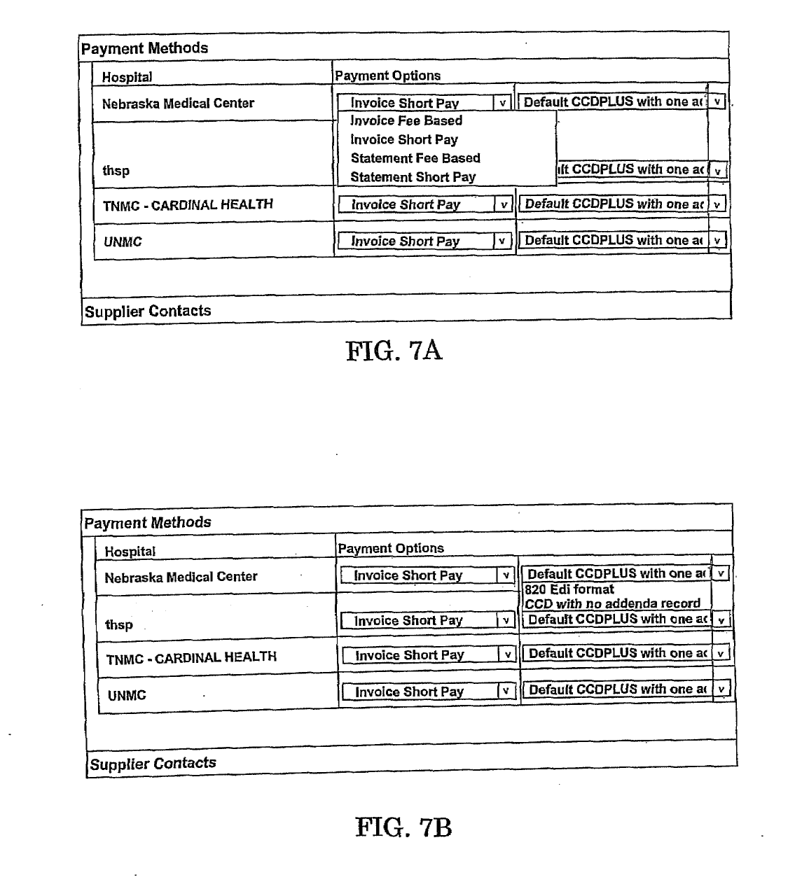

Term application module 350 retrieves term information from the database 340 to calculate a payment which the customer (payor) 12 actually pays to a supplier for at least one bill. The terms can be pre-agreed between the customer and the supplier 14, 16 or between the service provider 20 and the supplier 14, 16. Upon receipt of the customer's instructions on payment, the term application module 350 determines what amount the system needs to transfer to the supplier 14, 15 to settle the invoice associated the transaction identified by the customer 12 according to payment mode selected by the customer 12, (e.g., INVOICE FEE BASED, INVOICE SHORT PAY, STATEMENT FEE BASED, or STATEMENT SHORT PAY as shown in FIG. 7A), and the terms agreed with the supplier 14. In one embodiment, the term application module facilitates rapid automated invoice settlement. Funds are periodically or upon receipt of the customer's authorization withdrawn from the customer's LOC account 18, in one case, to a check disbursement settlement account so that a series of paper checks can be issued. In another case, funds are periodically or upon receipt of the customer's authorization withdrawn from customer's LOC account to an electronic funds transfer (EFT) disbursement settlement account.

As illustrated above, customer may select a payment format using the user interface 320. In another embodiment, the payment format is set up by the terms with the suppliers 14, 16. There are four ACH payment formats available to meet company and business needs for timely disbursements and collections. These are cash concentration or disbursement (CCD), cash concentration or disbursement plus addenda (CCD+), corporate trade exchange (CTX), and the soon-to-be obsolete corporate trade payments (CTP). It will be appreciated by those skilled in the art that the present invention is not limited by the particular ACH payment format(s) used. Addenda records allow the CCD+, CTP and CTX formats to both electronically transmit payments and payment-related information in standard formats between financial institutions.

The CCD payment format is the only corporate format that is not accompanied by addenda records. However, a reference number is placed in the entry detail record so that the payment and remittance advice can be reconciled by the seller (receiver).

The CCD+ format is the same as the CCD format with the addition of one addenda record. Part of the addenda record contains a payment-related information field in which data segments as defined by ASCIIx12 or NACHA-endorsed banking conventions are used. This addenda record allows the transmission of limited remittance information related to the payment.

The CTX format allows a company or business to electronically transmit one payment to cover multiple invoices and associated remittance information. The CTX format allows up to 9,999 addenda records. For CTX entries, the addenda are linked together with each succeeding addenda record carrying the next 80 characters of the message. The complete ASCIIx12 820 or 835 transaction set is “enveloped” within the CTX addenda records.

Payment modes and formats can be mixed and matched in a variety of ways. This is much different than a standard credit card situation in which there are limited options for vendor cash recognition. The reason for the multiple payment modes relates directly to how the vendor desires to be paid, given their preference (as a company), their level of technology, desire to automate the cash application process.

Payment process module 360 processes payments to each of the suppliers upon the terms and conditions of the transaction. In one embodiment, the payment process module provides a “sweep” of the web portal at 2:30 CST daily in order to process pending payments.

Invoice generating module 370 generates various invoices to the customer, such as a monthly invoice while report generating module 380 generates various report to the customer and its trading partners for the account balance, payment confirmation, payment notice, etc.

The customer 12 often can benefit by reducing the number of payments processed for supplies ordered from participating suppliers. All payments made on behalf of the customer 12 to all participating suppliers 14, 16 are on one monthly or any predetermined periodic statement. Further, the customer 12 benefits by a more rapid decrease in the unpaid principal and therefore saves on the interest charges that accrue on that unpaid principal. At the same time, it is desired that there always be enough money on hand to pay each bill. So any acceleration of payments cannot leave the system 100 short of funds to pay any bill that normally comes due later in the month. In one embodiment, the customer may order supplies and authorize payment on a daily basis while extending the payment terms up to 51 days.

With respect to browser presentation, in one embodiment, the system 100 presents a tabbed dialog user interface for a navigating user. Once all of the information on a tab is complete, the system 100 permits next tab to be viewed. The user interface provides additional buttons to expand and collapse all detail question branches. After each question is answered, the user interface advances focus via auto-scrolling to the next unanswered question of the application, where possible. FIGS. 7A and 7B show an exemplary graphical user interface that may be displayed in embodiments of the present invention when the customer 12 clicks on the top-down menu tab for the payment mode and payment format options, respectively. The system 100 also provides the option to automatically re-position the questionnaire so that the next unanswered question is displayed at the top of the screen. In one embodiment, the system 100 can customize the internet-based, exclusive website as to the electronic supplier payment instructions and negotiated terms. The system 100 provides the consumer 401 with a “payment template” in which to download approved payments (daily) for the consumers accounts payable system, and the consumer security access to “log on” to the exclusive web portal.

The general steps to set up the system of the present invention are as follows: 1. Buyer registers and subscribes to the system; 2. Credit provider will assess the credit worthiness of the buyer and grant the appropriate trade finance credit line to the buyer; 3. Buyer will receive the necessary security access to transact in the system; 4. Register the buyer's suppliers with the system; and 5. Sellers will receive the necessary security access to transact in the system.

The general steps of a transaction in the system of the present invention are: 1. Buyer and Seller negotiate terms; 2. Buyer submits purchase orders with the delivery, payment and other trade terms as agreed with the seller; 3. Buyer authorizes the system to settle at least one outstanding invoice (buyer select payment mode and format); 4. System process the settlement according to payment terms and payment mode authorized by the buyer; 5. System transfers the settled fund to the seller according to payment terms and payment format selected by the buyer.

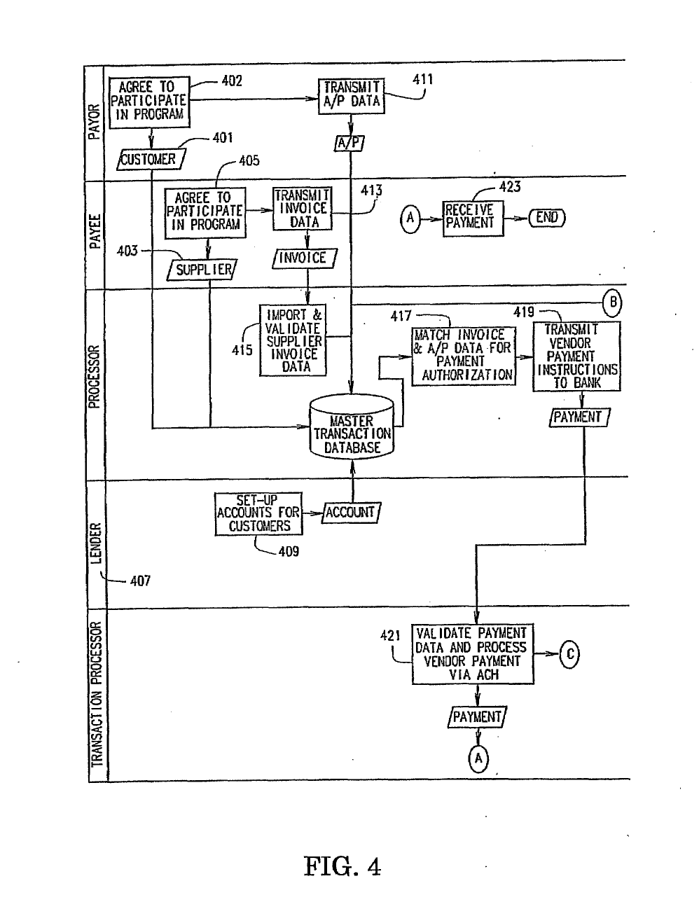

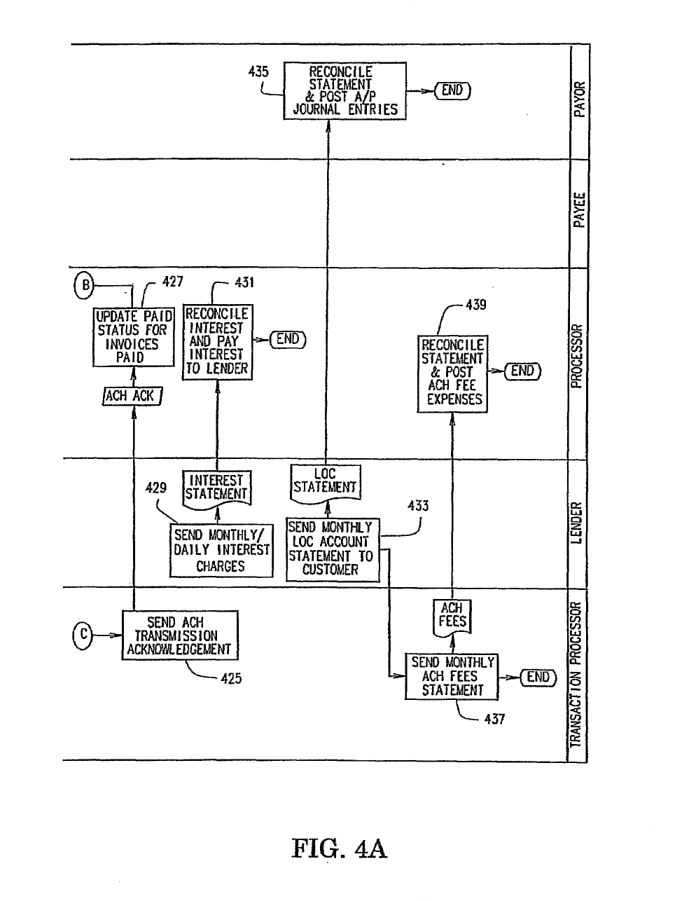

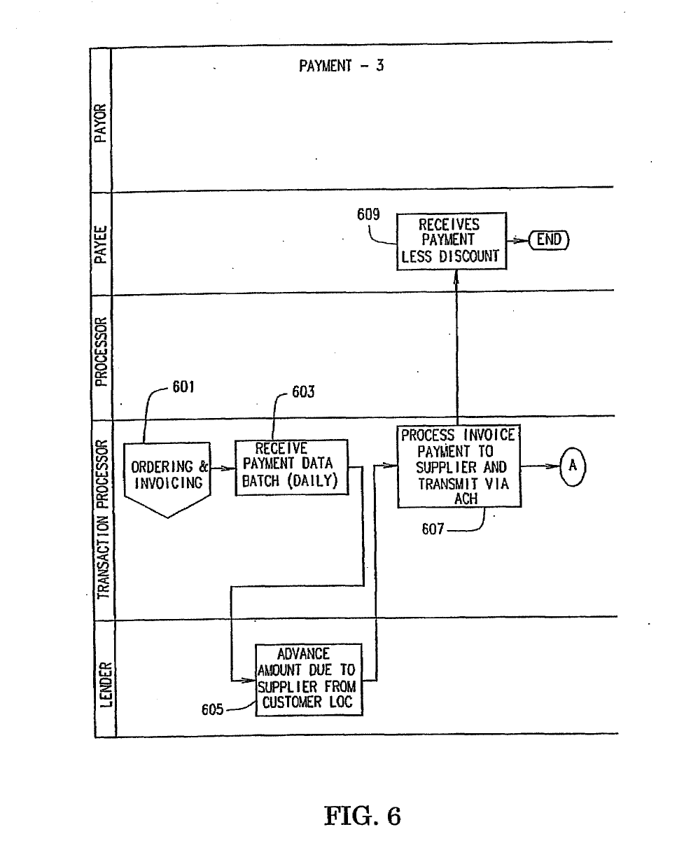

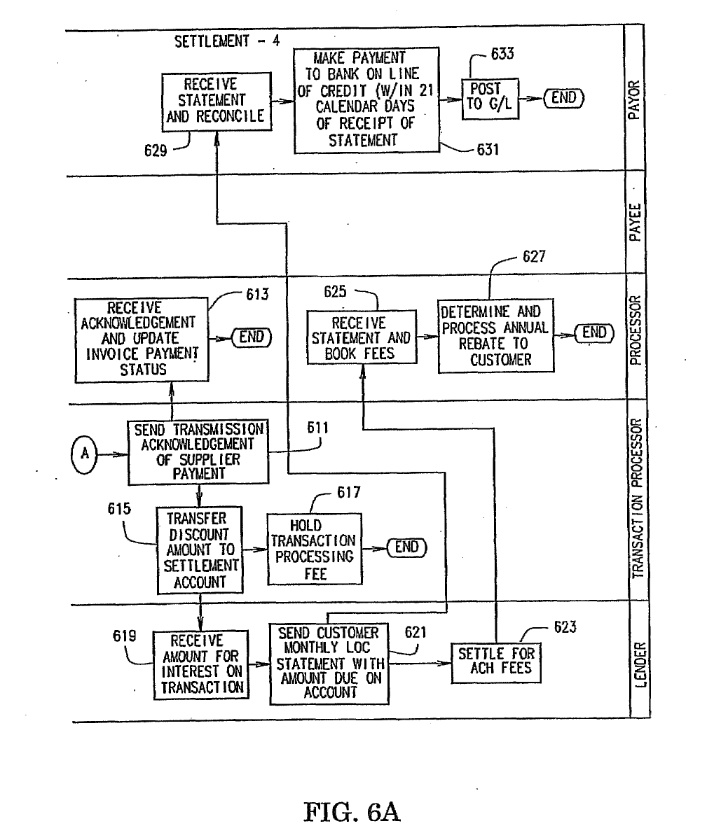

FIGS. 4-6 depict an illustrative process flow for operation of the system 100 in accordance with the present invention with the steps organized in columns associated with the party performing or directing the step, i.e., payor (buyer), payee (seller), processor 100 and lender. Referring to FIG. 4, at the step 402, the customer 401 agrees to participate in the program (step 402). Then, lender (credit provider) 407 will assess the credit worthiness of the buyer and grant the appropriate trade finance credit line to the buyer. After the account of LOC is set up at the step 409, the account information including the line of credit is stored in a Master Transaction Database. The supplier 403 can also participate in the program (step 405). In one embodiment, the service provider 20 assesses the supplier 403. In further embodiment, either the customer 401 or the service provider 20 agrees with the supplier 403 upon the terms of sale for facilitating rapid automated invoice settlement. Once the registration is set up, the system can process a transaction between the customer 401 and the supplier 403. In one embodiment, the system 100 assesses the consumer's current operational payment process and modifies it to segment participating suppliers.

At the step 413, the supplier 403 transmits invoices to the customer 401 and/or the system. In addition, the customer 401 authorizes payment and enters A/P data to a Master Transaction Database. The system 100 can import and validate the supplier 403 invoice data and store them in the database. Then, at the step 417, the system 100 matches the supplier invoice and the customer's A/P data for payment authorization. At the next step, the system 100 transmits vendor payment instructions to bank. The transaction processor validates payment data and processes vendor payment via ACH (step 421). Then, the transaction processor sends ACH transmission acknowledgement to the system 100 (step 425). Upon the supplier's receipt of the payment, the payment process is completed. For administration, the system 100 updates the payment status (step 427). The lender 407 charges the customer monthly or daily interest and the system 100 reconciles the interest and pays it to the lender 407 (steps 429, 431). The lender 407 usually sends a monthly LOC account statement to the customer 401 (step 433) and a monthly ACH fee statement to the system 100 (step 437). In one embodiment, the service provider 20 provides the consumer 401 a monthly statement of all transactions paid via the process for a 30 day period. The customer 401 and the service provider 20 reconcile the statements (steps 435, 439). For example, the consumer 401 remits a single payment to the credit facility bank, 21 days after the statement date, reflecting the principle amount due as presented on the statement. The service provider 20 collects a supplier fee payable to the bank account, consistent with the terms negotiated. Interest expense is billed by the lender for which the line of credit is drawn to the bank account. Payment is made by the bank account settling all interest due. In one embodiment, a rebate is issued to the consumer 401 based on compliance and volume.

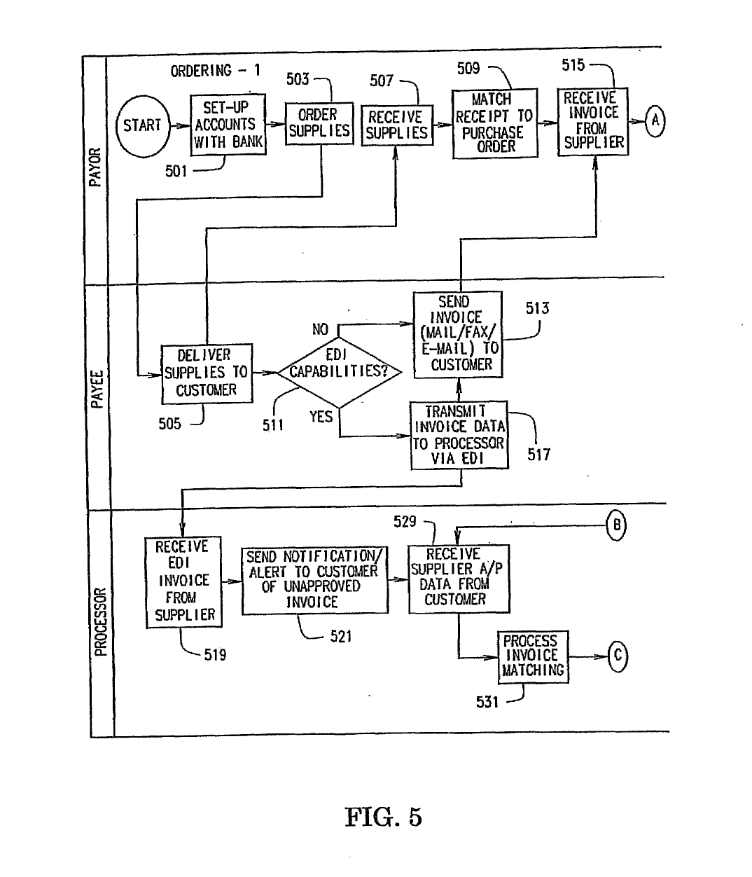

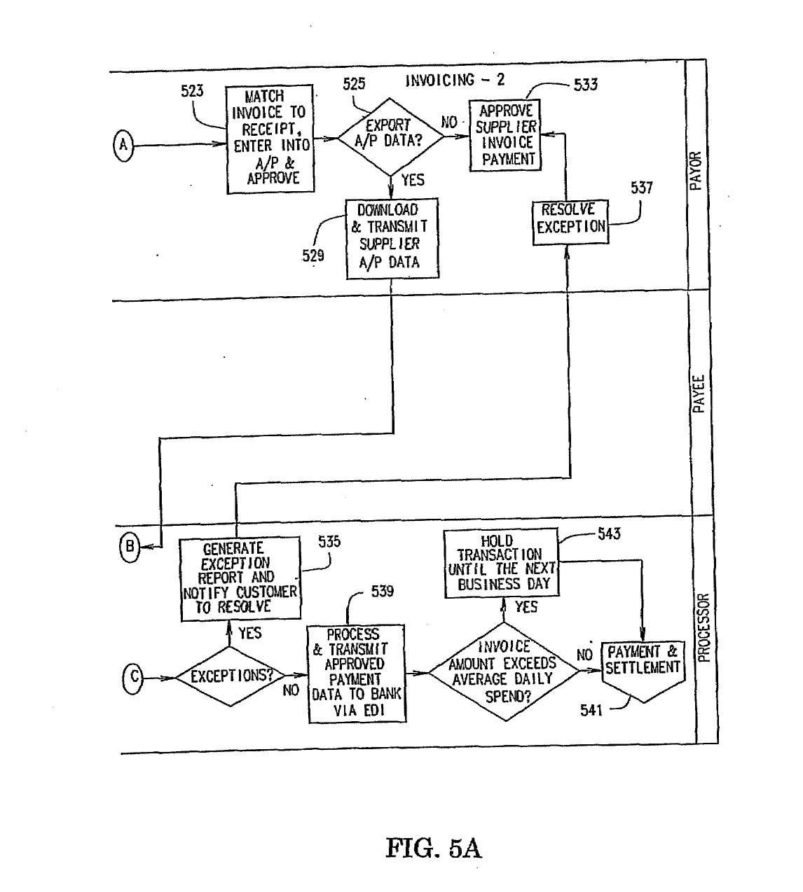

In addition, the present invention may be used to advantage in combination with the Electronic Data Interchange, a standard mechanism for exchanging business documents in standard format between computers. Referring to FIG. 5, the customer (payor) sets up an account with the system 100 (step 501). After the supplier 403 (payee) delivers goods to the customer (steps 503, 505, 507), the supplier 403 sends an invoice to the customer (step 513). Upon receipt of the invoice, the customer authorizes payment and enters A/P data to the system (steps 515, 523, 525, 527). If the EDI is capable, the supplier 403 will send the invoice data to the system in EDI format which enables the process the invoice and schedule payment either by check or electronic finds transfer (steps 517, 519). Then, at the step 521, the system sends notification to the customer of unapproved invoices. The system proceeds with the settlement process with the authorization from the customer.

The present invention allows the service provider 20 to collect more in interest paid to it from the suppliers (or LOC) than the service provider 20 pays the bank in interest charges. The fee is lower than a conventional credit card, but the service provider 20 still stands to realize a net profit after interest payment.

In one embodiment, the system 100 comprises a document management module (not shown). The document management module provides ability to manage many different types of documents and all of its components that make it. Each document has different templates which can be ordered by the use of drag and drop. A template represents one or more pages of a document. All templates have distinct properties. The majority of the templates are XSLT style sheets. When an XSLT style sheet is combined with an XML file, dynamic content is provided in almost real-time document generation. The templates that make up a document have an order in which they will be displayed in a generated document. Clicking an edit button displays options to re-order, add, or delete templates. This queue of document templates contains all possible templates that can make up a document. Each template has a set of rules that define when certain templates should be included in the document generation process. A document indexing interface allows for incoming documents to be associated with the appropriate claim, policy or agency. The incoming categories or tabs can be administratively defined to look at virtually any network location, creating a consolidated single point of view. Documents can be created by merging dynamic data with static form templates stored in a template library.

In order to maintain audit trails of document changes and revisions to meet business and legal requirements, generations of data will be stored in the database with date/time stamps so at any point in time, a document can be reconstituted for viewing and printing as it appeared when it was initially created prior to latest endorsements or modifications.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A computer-implemented method of facilitating a financial settlement between a multiple users through a fund transfer system, the method comprising the steps of:
providing a first user with an interface for receiving an instruction to settle, at least in part, a financial obligation to a second user wherein the first user is a registered user of a fund transfer system;
providing a plurality of payment modes suitable for different payment processing;
receiving said instruction from the first user wherein the instruction includes:
an identifier of the second user;
information on said financial obligation; and
a payment format suitable for the second user;
determining a value to settle, at least in part, the financial obligation to the second user based, at least in part, upon said instruction and predetermined rules wherein the predetermined rules are associated with contractual terms agreed with the second user;
transferring said determined value to the second user on behalf of the first user from the first user's account on a first schedule wherein said determined value is transferred to the second user by using the payment format suitable for the second user;
receiving funds from the first user to credit the first user's line of credit on a second schedule.

2. The computer-implemented method wherein plurality of payment modes comprise invoice fee based, invoice short pay, statement fee based and statement short pay.

3. The computer-implemented method of claim 1, wherein the payment format comprises CCD, CCD-plus, PPD, PPD-plus, CIE or CTX.

4. The computer-implemented method of claim 1, wherein the financial obligation comprises a plurality of unpaid bills

5. The computer-implemented method of claim 1, wherein the first user's account is a line of credit.

6. The computer-implemented method of claim 1, wherein the predetermined rules are user defined.
